(19) United States
(12) Patent Application Publication
(10) Pub. No.: US 2024/0402356 A1
(43) Pub. Date: Dec. 5, 2024

(54) HYBRID SIGNAL ACQUISITION AND TRACKING DEVICE

(71) Applicant: BAE Systems Information and Electronic Systems Integration Inc., Nashua, NH (US)

(72) Inventors: John E. Acheson, Anamosa, IA (US); Mitchell T. Dennis, Cedar Rapids, IA (US); John R. Bader, Cedar Rapids, IA (US); Jordan M. Jump, Cedar Rapids, IA (US)

(73) Assignee: BAE Systems Information and Electronic Systems Integration Inc., Nashua, NH (US)

(21) Appl. No.: 17/654,308

(22) Filed: Mar. 10, 2022

(51) Int. Cl. G01S 19/30; G01S 19/37

(52) U.S. Cl. CPC G01S 19/30; G01S 19/37

(57) ABSTRACT

A signal acquisition and tracking device includes an input configured to receive a global navigation satellite system (GNSS) signal, a software-based processor configured to execute software instructions to acquire the GNSS signal via the input and to generate, based on the acquired signal, one or more signal tracking parameters, and a hardware logic circuit operatively coupled to the processor. The logic circuit is configured to track the GNSS signal independently of the processor using the one or more signal tracking parameters generated by the processor. In some examples, the processor is configured to pull in and center the GNSS signal in time and frequency, and the logic circuit is further configured to track the pulled in and centered GNSS signal independently of the processor. In some examples, the processor acquires the signal and then hands-off control to the logic circuit for subsequent tracking of the signal.

### STATEMENT OF GOVERNMENT INTEREST

This invention was made with United States Government assistance under Contract No. FA8807 19 C 0003, awarded by the Space & Missile Systems Center. The United States Government has certain rights in this invention.

### FIELD OF DISCLOSURE

The present disclosure relates to signal tracking, and more particularly, to techniques for tracking signals using a hybrid software-hardware signal acquisition and tracking device.

### BACKGROUND

A signal tracking device is any device capable of acquiring a signal and subsequently receiving, or tracking, information in the signal over time. For example, a satellite navigation device, also referred to as a receiver, is a device capable of acquiring and tracking radio signals transmitted by global navigation satellite systems (GNSS) satellites orbiting Earth. Based on the information in the signals, the receiver calculates the geographical position of the device on Earth. Such a device may display the position on a map or otherwise provide positional information, such as geographical coordinates and altitude. In some applications, such as real time navigation, the device uses a high processing rate to increase positional accuracy, particularly when the device is in motion. Such mobile devices are often battery powered and thus continued operation is limited by the remaining battery charge.

However, the power consumption of the device increases as the processing rate increases. Furthermore, the power consumption of the device also increases when the signals are weak, such as when the line-of-sight to the signal source (e.g., the GNSS satellites) is obstructed by structures, terrain, or foliage, because the device performs additional processing on the weak signals to reduce positional error. Such increased power consumption thus reduces the operational availability of the device and necessitates larger capacity and/or additional batteries for extended operation. Therefore, non-trivial problems remain with respect to signal tracking devices.

### BRIEF DESCRIPTION OF THE DRAWINGS

FIG. 1 shows a signal acquisition and tracking system, in accordance with an example embodiment of the present disclosure.

FIG. 2 is a block diagram of a portion of a receiver of the system of FIG. 1, in accordance with an example embodiment of the present disclosure.

FIG. 3 is a flow diagram of a software to hardware tracking handoff process for the receiver of FIG. 1, in accordance with an example of the present disclosure.

FIG. 4 is a schematic block diagram of a portion of the receiver of the system of FIG. 1. in accordance with an example of the present disclosure.

FIG. 5 is a flow diagram of an example signal tracking process, in accordance with an embodiment of the present disclosure.

FIG. 6 is a flow diagram of another example signal tracking process, in accordance with an embodiment of the present disclosure.

Although the following detailed description will proceed with reference being made to illustrative embodiments, many alternatives, modifications, and variations thereof will be apparent in light of this disclosure.

### DETAILED DESCRIPTION

In accordance with an embodiment of the present disclosure, a signal acquisition and tracking device includes an input configured to receive a GNSS signal, a software-based processor configured to execute software instructions to acquire the GNSS signal via the input and to generate, based on the acquired signal, one or more signal tracking parameters, and a hardware logic circuit operatively coupled to the processor. The logic circuit is configured to track the GNSS signal independently of the processor using the one or more signal tracking parameters generated by the processor. In some examples, the processor is configured to pull in and center the GNSS signal in time and frequency, and the logic circuit is further configured to track the pulled in and centered GNSS signal independently of the processor. In some examples, the processor acquires the signal and then hands-off control to the logic circuit for subsequent tracking of the signal. In some examples, the logic circuit is implemented as an application specific integrated circuit (ASIC) configured to track the GNSS signal or a field-programmable gate array (FPGA) configured to track the GNSS signal. The device reduces power consumption by handing off high rate processing for tracking signals from the software-based processor to the hardware logic circuit, which reduces the number of required calculations in the processor (software) and associated RAM chips by approximately 50 to 75%. This allows the software processor to run at slower clock speeds and utilize high power memory components far less often, which saves significant energy in battery-powered devices.

### Overview

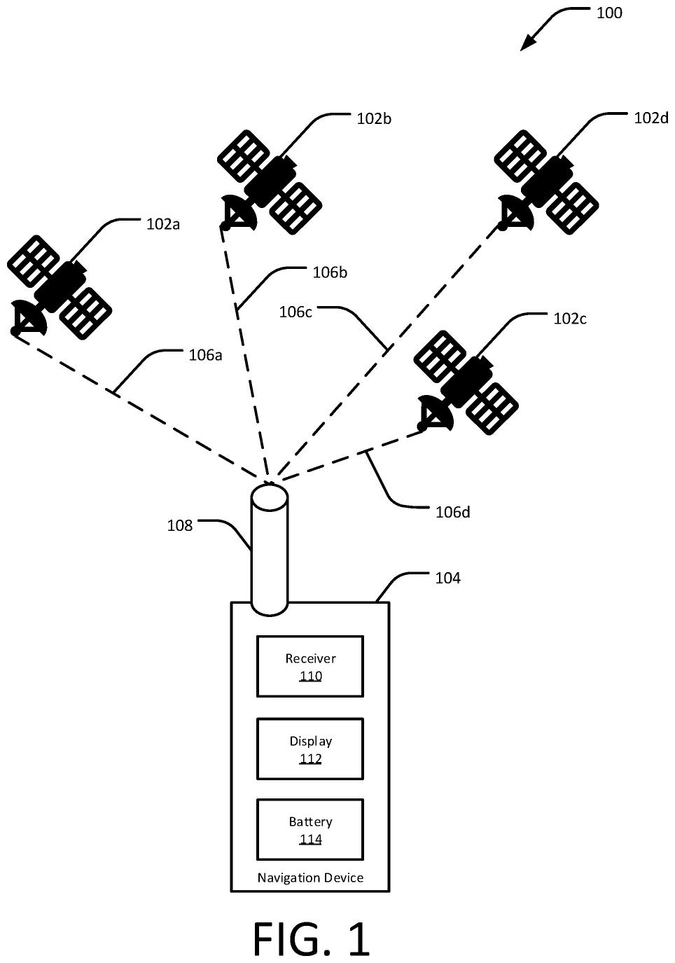

FIG. 1 shows a signal acquisition and tracking system 100, in accordance with an example embodiment of the present disclosure. The system 100 includes a plurality of satellites 102a, 102b, 102c, 102d in Earth orbit and a navigation device 104. Only four satellites are shown for clarity, but in practice, in a given satellite navigation system, such as the Global Positioning System (GPS), there may be many more satellites in orbit around the Earth (e.g., up to 32 satellites). Each satellite 102a, 102b, 102c, 102d transmits a unique radio signal 106a, 106b, 106c, 106d, which is received by an antenna 108 and processed by a receiver 110 of the navigation device 104. The receiver 110 is engaged with the navigation device 104 and powered by a battery 114 or other source of power. Information regarding the position of the navigation device 104 is shown graphically on a display 112. The navigation device 104 may be suitable for route planning and/or navigation. In such cases, the graphically displayed information may also include navigation (routing) information.

In general, satellite navigation is based on the range, or distance, between the receiver 110 and the known positions of the satellites at a given point in time. Because the expected positions of the satellites are known to the receiver 110, the location of the receiver 110 can be calculated by determining the distances from each of at least four satellites to the receiver 110 and estimating the position and time from those distances. The distance is a function of the amount of time the signals 106a, 106b, 106c, 106d take to travel from the respective satellites 102a, 102b, 102c, 102d to the receiver 110 via the antenna 108. However, before the location of the receiver 110 can be calculated, the receiver 110 must first acquire the signals 106a, 106b, 106c, 106d transmitted by each of the satellites 102a, 102b, 102c, 102d. Signal acquisition includes identifying the source (satellite) of each signal so that the receiver 110 can determine the respective distances from the satellites 102a, 102b, 102c, 102d, and accordingly the location of the receiver 110, based on the known or expected locations of the satellites in the GPS constellation. Once the signals 106a, 106b, 106c, 106d are acquired, the receiver 110 can track the signals 106a, 106b, 106c, 106d over time to update the location of the receiver 110 as the satellites 102a, 102b, 102c, 102d and the receiver 110 change distances relative to one another.

To this end, and in accordance with an example of the present disclosure, the receiver 110 is configured to perform signal acquisition and signal tracking. The receiver 110 processes the signals 106a, 106b, 106c, 106d received on the antenna 108 to determine position, velocity, and/or timing information. For each of the satellites 102a, 102b, 102c, 102d, the receiver 110 first acquires the signals 106a, 106b, 106c, 106d, and then continuously tracks the signals 106a, 106b, 106c, 106d as long as the signals are available to the receiver 110. Acquiring each signal 106a. 106b, 106c, 106d includes determining the frequency and code phase of information encoded in the respective signal by the satellites 102a, 102b, 102c, 102d. Tracking each signal 106a, 106b, 106c. 106d includes continuously adjusting the estimated frequency and phase to match the received signal as closely as possible using a frequency lock loop (FLL) and/or a phase lock loop (PLL). Note that acquisition is performed to start using a particular satellite, but tracking is performed as long as that satellite is in use.

In overview of the signal tracking operation, the signal 106a, 106b, 106c, 106d transmitted by each satellite 102a, 102b, 102c, 102d contains information on the position of that satellite, which is used by the receiver 110 to calculate a position relative to the satellites 102a, 102b, 102c, 102d. In use, the receiver 110 receives the signals 106a, 106b, 106c, 106d from the satellites 102a, 102b, 102c, 102d and uses information encoded in the signals to calculate positional data, which can be used, for example, to display the location of the navigation device 104 on the display 112 (e.g., via a map or numerical coordinates), or for other purposes, such as routing, targeting, ranging, time dissemination, etc.

In the typical mode of operation, each signal 106a, 106b, 106c, 106d is acquired using a signal acquisition engine configured to search large time and frequency uncertainties and to produce a statistic that is used to initialize a tracking channel. During initialization of the tracking channel, the signal acquisition engine centers each signal 106a, 106b, 106c, 106d in time and frequency (Doppler). After each signal 106a, 106b, 106c, 106d is centered, the signal acquisition engine hands the statistic to a signal tracking engine where information superimposed on each signal 106a, 106b, 106c, 106d is used to compute the respective range to the satellite transmitting the signal. In practice, a minimum of four satellites must have line-of-sight with the navigation device 104 in order for the receiver 110 to determine position in three dimensions (e.g., latitude, longitude, and elevation). However, under certain circumstances the receiver 110 can track position using less than four satellites, at least temporarily, after acquisition.

In more detail, the receiver 110 acquires the input signal 202 using logic executed by a software-based processor (e.g., a processor configured to executed software instructions). Signal acquisition includes identifying the data encoded in the signal, such as a pseudorandom noise number (PRN) code that uniquely identifies the ranging codes used by the satellite transmitting the signal, along with the signal carrier frequency and the code phase. Each satellite uses a unique PRN code, which does not correlate well with the PRN code of any other satellite, and thus correlation can be used to uniquely correlate the signals 106a, 106b, 106c, 106d with the PRN code associated with a given satellite 102a, 102b, 102c, 102d. For example, both the receiver 110 and each satellite 102a, 102b, 102c, 102d generate the same PRN code at the same time. These two codes—the satellite-generated PRN code and the receiver-generated PRN code—are correlated by the receiver 110 to identify the satellite transmitting the corresponding PRN code. However, due to signal propagation delay, the receiver 110 receives the PRN code transmitted by each satellite 102a, 102b, 102c, 102d later than the PRN code was generated by the receiver 110. Thus, due to this time delay, the PRN code received by the receiver 110 does not correlate (align) with the PRN code generated by the receiver 110 even though they are identical. The amount of time shift needed to correlate the PRN codes represents the propagation delay of the signal 106a, 106b, 106c, 106d; that is, the time it took the signal 106a, 106b, 106c, 106d to travel from the respective satellite 102a, 102b, 102c, 102d to the receiver 110. Additional information encoded on the carrier can be used to further correlate the signals 106a, 106b, 106c, 106d.

It will be appreciated that the carrier is complex number involving real and imaginary sinusoidal components, and therefore signal acquisition can be computationally expensive, making signal acquisition suited for a flexible software implementation. However, once the signal has been acquired, carrier frequency tracking and PRN code tracking are used to determine proper alignment to the satellite's PRN code. Such tracking usually involves incremental adjustments to maintain alignment, and an internal clock can be used for subsequent reading of the data in stable environments. Therefore, it will be further appreciated that signal tracking is less computationally expensive than signal acquisition and is well-suited for a hardware (e.g., FPGA or ASIC) implementation, which requires less power than using a software processor and associated memory.

As noted above, there are non-trivial problems associated with existing signal tracking devices, such as GNSS receivers. For example, existing GNSS receivers consume more power while acquiring the signals than during subsequent tracking of those signals. Existing receiver designs that utilize software for both signal acquisition and tracking provide rapid positioning information but at the expense of greater power consumption due to the relatively inefficient data processing requirements associated with separate processor and memory components. By contrast, existing receiver designs that utilize hardware for both signal acquisition and tracking are more power efficient than software implementations but are more complex and expensive to build than software implementations. Furthermore, hardware implementations, such as field gate programmable arrays (FPGA) and application-specific integrated circuits (ASIC), are not as flexible as software implementations due to the fixed logic of the circuit. Thus, trade-offs between software and hardware implementations are apparent.

In accordance with examples of the present disclosure, a low power, hybrid software-hardware signal acquisition and tracking device is disclosed. In overview, the device includes a hardware-based signal tracking logic circuit that supplements a software-based signal tracking module configured to perform signal acquisition. The hybrid software-hardware signal acquisition and tracking device can be used to replace legacy signal tracking designs to reduce power and enhance signal tracking performance against jamming under dynamic motion conditions. The hardware tracking logic circuit can, in some examples, be implemented with Very High-Speed Integrated Circuit Hardware Description Language (VHDL) code synthesized for FPGA or ASIC chip applications to conserve power and increase performance. The software signal tracking module that can be set up to form carrier, subcarrier, and code discriminators, which are input to Phase Locked Loops (PLL) and Frequency Locked Loops (FLL) for first, second, or third order signal tracking prior to handing off tracking operations to the hardware tracking logic circuit. The device further provides features such as carrier and code aiding techniques and configurable bandwidth filters to set the tracking loop bandwidths. The device is designed to perform simplified handovers from the software signal tracking module to the hardware signal tracking logic circuit as signals are handed over from acquisition, re-acquisition, and signal centering processes through the use of separate rate command registers for hardware and software inputs. Rate command interfaces are provided for a blended handover in either direction (e.g., from software to hardware tracking and from hardware to software tracking), along with the ability to pass the signal back to software tracking without dropping track in case of signal obstructions from foliage or buildings.

It will be appreciated that power capacity is an important feature for GPS applications that utilize batteries, such as handheld or body-worn receiver devices. A significant consumer of battery energy is the GPS receiver while operating in a tracking state, which is the mode of operation over a majority of the receiver operational period. To this end, the hybrid software-hardware device reduces power consumption during steady state signal tracking by approximately two-thirds (e.g., about 50 mW) in comparison to some existing signal tracking devices that utilize 100 Hz/50 Hz processors and off die application processor memory. For example, the device allows closed loop hardware (e.g., ASIC) tracking of signals without incurring long delays and higher power consumption of software processors and memory chips, while providing the flexibility of a software implementation during the signal acquisition, pull-in, and centering stages. The device saves power by handing off high rate processing for tracking signals from the software tracking module to the hardware tracking module. The software signal tracking module utilizes a processor and external memory to measure the signal tracking error and compute an updated command to the hardware signal tracking logic circuit. Thus, by handing off the signal tracking calculations from the software processor to the hardware logic circuit, the device reduces the number of required calculations in the processor (software) and associated RAM chips by approximately 50 to 75%. This allows the software processor to run at slower clock speeds and utilize high power memory components far less often, which saves significant energy. The device can provide approximately 10 20% power savings to the battery-operated receiver during tracking operations, leading to significant battery life extension of the device.

Embodiments of the disclosed device use a closed loop hardware signal tracking logic circuit, which improves tracking performance by reducing or eliminating the processing delay time or latency. For instance, instead of forming measurements in hardware that are then sent to software, processed, and then written back into hardware to be applied in the future, the hardware signal tracking logic circuit allows for immediate calculation of the correct feedback terms with immediate application of the updated feedback to the tracking loops independently of the software-based processor. By eliminating nearly all processing latency, the tracking loops are able to track with higher platform dynamics while at equivalent jamming levels. This is useful, for example, in military GPS applications where platform maneuverability is needed in hostile environments while continuing to provide accurate position, velocity and time. It will be appreciated that embodiments of the disclosed device can be applied to tracking of any signal, including GNSS applications, communications, and electronic warfare (EW) signals.

In an example, the device uses software executed by a processor to acquire, pull in, and center the signal, and then, in response to pulling in and centering the signal, uses a separate hardware logic circuit to perform closed-loop tracking of the signal while at least partially reducing the processing load on the off-die software processor and associated memory. In some embodiments, at least some hardware tracking features, such as tracking state, loop type (e.g. frequency lock loop (FLL) and phase lock loop (PLL)), bandwidth, and rate are software configurable. Certain other features, such as receiver pseudo-range (e.g., the pseudo-distance between a satellite and the receiver device), delta range (e.g., a change in receiver position measured as velocity), and position, velocity, and time (PVT), are performed in software. Numerous configurations and variations and other example use cases will be appreciated in light of this disclosure.

### Example Receiver

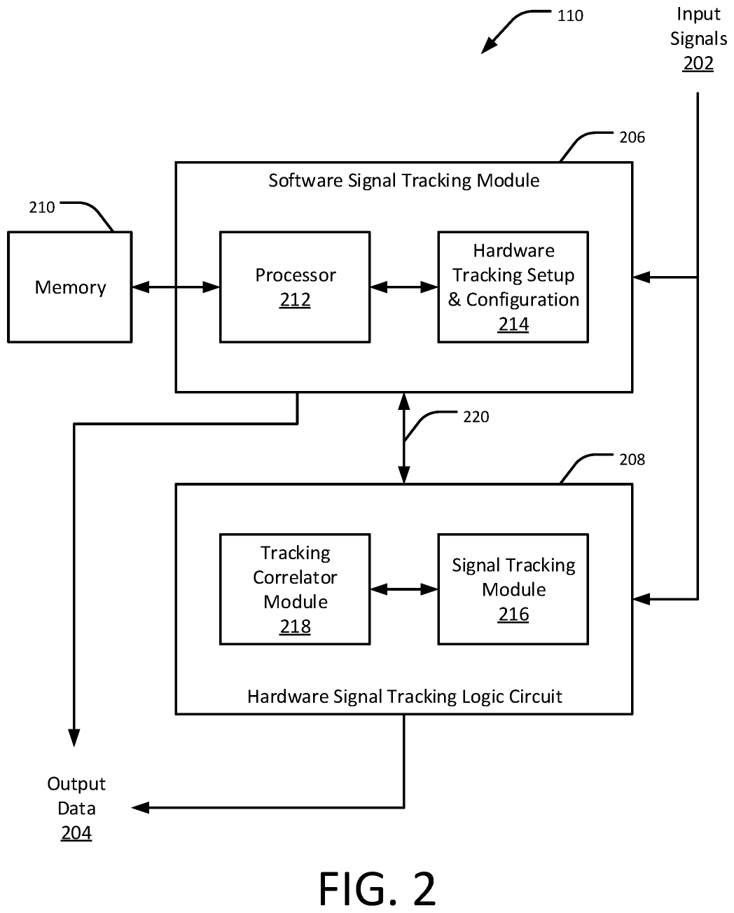

FIG. 2 is a block diagram of a portion of the receiver 110 of the device 104 of FIG. 1, in accordance with an example of the present disclosure. The receiver 110 is configured to receive one or more input signals 202, such as any of the satellite signals 106a, 106b, 106c, 106d, and to produce output data 204, which can include positional and/or time data calculated from the one or more input signals 202. For example, the input signals 202 can include signals transmitted by, and received from, three or more of the satellites 102a, 102b, 102c, 102d in a GPS or other GNSS constellation, where each of the input signals 202 is encoded with information uniquely identifying the respective satellites (e.g., PRN codes). In this example, the receiver 110 is configured to acquire and track the input signals 202 while the input signals 202 are present at the antenna 108.

The receiver 110 includes a software signal tracking module 204, a hardware signal tracking logic circuit 206, a memory 210, and a bidirectional communication channel 220 between the software signal tracking module 206 and the hardware signal tracking logic circuit 208. The software signal tracking module 206 and the hardware signal tracking logic circuit 208 are each powered by the battery 114. The software signal tracking module 204 includes a processor 212 configured to read from, and write to, a hardware tracking setup and configuration 214, which includes signal tracking parameters that can be exchanged via the bidirectional communications channel 220 between the software signal tracking module 206 and the hardware signal tracking logic circuit 208. The hardware signal tracking logic circuit 208 includes a signal tracking module 216 and a tracking correlator module 218. The software signal tracking module 206 and the hardware signal tracking logic circuit 208 are each configured to track the input signals 202 after they have been acquired; that is, either the software signal tracking module 206 or the hardware signal tracking logic circuit 208 can perform tracking operations after the signal has been acquired by the processor 212. For instance, the software signal tracking module 206 can hand over signal tracking operations to the hardware signal tracking logic circuit 208, which then tracks the input signals 202 independently of the processor 212 in the software signal tracking module 206. Further, the hardware signal tracking logic circuit 208 can hand signal tracking operations back to the software signal tracking module 206, for example, when signal tracking is lost or interrupted, such as by structures, terrain, or foliage. An advantage provided by the hardware signal tracking logic circuit 208 is to reduce the power consumed by the receiver 110 while the hardware signal tracking logic circuit 208 is performing tracking operations, since the hardware signal tracking logic circuit 208 is an application-specific logic circuit that uses less power to operate than the processor 212 consumes while performing the tracking operations.

To this end, examples of the present disclosure include a hybrid software-hardware signal acquisition and tracking device, where signal acquisition is performed by software and subsequent signal tracking is performed by the software signal tracking module 204 and the hardware signal tracking logic circuit 208. Depending on the configuration, the software signal tracking module 204 hands over signal tracking operations to the hardware signal tracking logic circuit 208 and then shuts down or otherwise reduces processing by the software module, which reduces power consumption significantly. If the dynamics of the receiver 110 (e.g., due to motion of the receiver or the satellites, or due to a loss of signal) cause a change in the strength of the received signal, or otherwise necessitate a change to a different satellite signal, the hardware signal tracking logic circuit 208 hands control back to the software signal tracking module 204. To reduce the power consumption of the software processor 212, the processor 212 limits high update rate applications and spends more time in hibernation or an idle state. At rates faster than approximately 1 Hz, or in response to an input stimulus, an interrupt is issued to wake up the software processor 212 to process the incoming data from the input signals 202.

The processor 212 can be any suitable processor, and may include one or more coprocessors or controllers, such as a signal processor, to assist in acquisition and tracking of one or more signals. In some embodiments, the processor 212 can be implemented as any number of processor cores. The processor 212 (or processor cores) can be any type of processor, such as, for example, a microprocessor, an embedded processor, a digital signal processor (DSP), a graphics processor (GPU), a network processor, a field programmable gate array or other device configured to execute code. The processor 212 can include multithreaded cores in that they may include more than one hardware thread context (or “logical processor”) per core. The processor 212 can be implemented as a complex instruction set computer (CISC) or a reduced instruction set computer (RISC) processor. The memory 210 can be implemented using any suitable type of digital storage including, for example, flash memory and/or random-access memory (RAM). The memory 210 can be implemented as a volatile memory device such as a RAM, dynamic RAM (DRAM), or static RAM (SRAM) device. In some embodiments, the components of the receiver 110 may be hardware components, firmware components, software components or any suitable combination of hardware, firmware or software.

### Software Tracking to Hardware Tracking Handoff

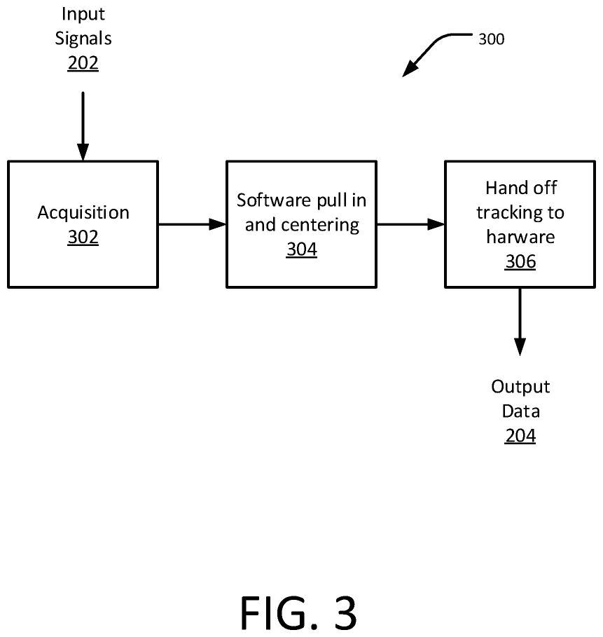

FIG. 3 is a flow diagram of a software to hardware tracking handoff process 300 for the receiver 110 of the device 104 of FIG. 1, in accordance with an example of the present disclosure. The receiver 110 acquires the input signals 202 using an acquisition process 302 that is designed for searching large time and frequency uncertainties, as will be understood by one of skill in the art. Once the input signals 202 are acquired, the receiver 110 produces a statistic that is used to initialize a tracking channel in software. As the tracking channel is initialized during acquisition, the processor 212 pulls in and centers 304 the input signals 202 in time and frequency (Doppler) before entering a tracking state where information can be used to compute range to the satellites.

After the processor 212 has centered the input signals 202 and engaged carrier and code tracking loops, the processor 212 can track the input signals 202 or, alternatively, hand tracking operations off 306 to the hardware signal tracking logic circuit 208. To initiate the handoff, the processor 212 provides the hardware tracking setup and configuration 214 to the hardware signal tracking logic circuit 208. The hardware tracking setup and configuration 212 enables the signal tracking module 216 to take over or otherwise assume tracking operations from the processor 212, which allows the software tracking module 206 to hibernate or otherwise reduce operations. Examples of the hardware tracking setup and configuration 212 include: carrier and code loop controller gain terms; carrier and code discriminator configuration for computing a tracking error against a target value; signal integration intervals; and waveform configuration values, such as carrier rate to code rate ratios and gains. Additional configuration information includes, for example, carrier phase locked loop or frequency locked loop dynamics, such as jerk, acceleration, and velocity; and code loop dynamics, such as velocity.

### Hardware Tracking to Software Tracking Handoff

When the system is transitioning from hardware tracking to software tracking, the software reads the current signal dynamics states (e.g., the hardware tracking setup and configuration 214) from the hardware signal tracking logic circuit 208, which are provided via bidirectional communications 220 between the hardware signal tracking circuit 208 and the software signal tracking module 206. Then, the processor 212 resume signal tracking operations independently of the hardware signal tracking logic circuit 208.

### Tracking Handoff Schematic

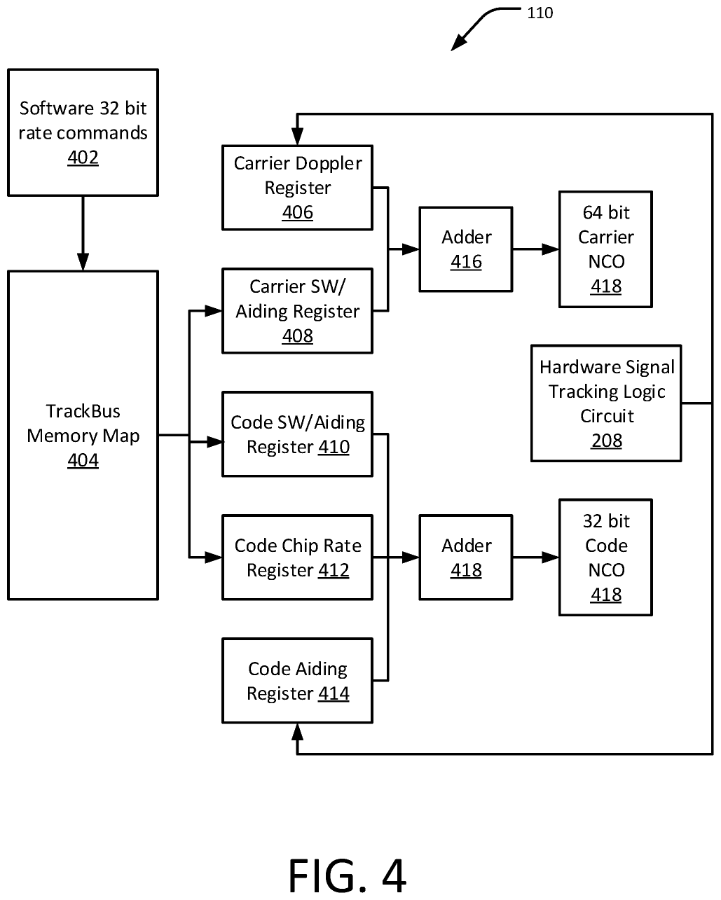

FIG. 4 is a schematic block diagram of a portion of the receiver 110 of FIG. 1, in accordance with an example of the present disclosure. GPS signals have two fundamental parts: carrier and code. The carrier equates to the transmission frequency or sinusoidal wave that the base signal is modulated by to be transmitted. The PRN code for GPS signals is a Code Division Multiple Access (CDMA) sequence of known pseudo random bits that are tracked for time alignment on the received signal. To successfully track a GPS or GNSS signal, both carrier and code parts of the signal are resolved by the receiver 110 using 32 bit rate commands 402. These parts of the signal are handed off from the software signal tracking module 206 to the hardware signal tracking logic circuit 208.

The TrackBus Memory Map 404 includes registers in hardware that latch and hold the configuration value that software writes into the hardware tracking setup and configuration 212. These values are latched and held when written by the configuration bus and not immediately applied to the signal tracking module 216.

A carrier section of the receiver 110 includes a Carrier Doppler Register 406 and a Carrier Software Aiding Register 408. The Carrier Doppler Register 406 is latched on update and holds an updated carrier Doppler rate command from the hardware signal tracking logic circuit 208. The values in the Carrier Doppler Register 406 are latched and applied immediately when written. Latency is removed from the tracking function by allowing the new rate commands to be applied immediately. Elimination of latency improves tracking performance. The Carrier Software Aiding Register 408 is latched on a synchronized system timer (Tsys) and holds the carrier Doppler rate command 402 from software. The rate command 402 is latched and applied on the synchronized system timer across all channels (satellites/signals) being tracked. The synchronization allows application of a rate command for a known quantity of time in the channel hardware.

In some examples, the carrier is shifted to a baseband prior to entering the hardware signal tracking logic circuit 208, which reduces the complexity of the receiver 110. In this case, all carrier numerically controlled oscillator (NCO) commands have a zero bias and are driven by line-of-sight measurements of the input signals 202. All frequencies are scaled to operate in the same direction regardless of the input signal 202 being processed. Any residual carrier shifts are due to Doppler and change in range between the receiver and the transmitter. An adder 416 combines carrier rate commands from both hardware tracking and software tracking, such as when the software is fed rate aiding information from inertial sensors or during a handoff from software to hardware tracking. A 64 bit carrier NCO is a 64 bit accumulator that adds the incoming 32 bit carrier rate commands on each processed signal sample. The 64 bits of the accumulator represent the code phase of an individual sinusoid in the lower 32 bits and the integrated count of the number of sinusoids in the upper 32 bits. The lower 32 bits of the 64 bit accumulator are used to compute the phase state (0 to 360 degrees) of a sinusoidal wave. The upper 32 bits of the accumulator are used to determine how many carrier cycles have moved due to Doppler since the signal tracking began. The number of carrier cycles that have moved represents a change in the range between the receiver and the satellite.

A code section of the receiver 110 includes a Code Software Aiding Register 410, a Code Chip Rate register 412, and a Code Aiding Register 414. The Code Software Aiding Register 410 is latched on the synchronized system timer (Tsys) and holds the code Doppler rate command from software. The code rate command is latched and applied on a synchronized system timer across all channels (satellites/signals) being tracked. This synchronization allows application of a rate command for a known quantity of time in the channel hardware. The Code Chip Rate Register 412 is latched on the synchronized system timer (Tsys). Where the input carrier is assumed to be at baseband, the code sequence has a nominal rate command independent of Doppler. For example, the nominal rate is 1.023 million chips per second. The Code Aiding Register 414 is latched when an updated code Doppler rate command is received from the signal tracking module 216. The values in this register are latched and applied immediately when written. Latency is removed from the tracking feedback system by allowing application of the new rate commands immediately. Elimination of latency improves tracking system performance. An adder 418 combines code rate commands from both hardware tracking and software tracking, such as when the software is fed rate aiding information from inertial sensors or during a handoff from software to hardware tracking. A 32 bit code NCO is a 32 bit accumulator that adds the incoming 32 bit code rate commands on each processed signal sample. The 32 bits of the accumulator represent the chip phase of an individual sinusoid.

The code chipping rate/code doppler commands are rate driven. A goal of the receiver 110 is to match the rate of change for both incoming code and carrier components of the input signals 202 by speeding up and slowing down until the signal components are brought “in phase” with a target. The carrier and code portions of the signal have unique characteristics. With respect to the carrier characteristics, the carrier tracking is very sensitive due to the high frequency used to transmit the signal, allowing for improved relative tracking accuracy, but not absolute accuracy. Standalone un-aided GPS receivers cannot resolve exactly how many carrier cycles are between the receiver and transmitter. This is done, for instance, on real time kinematic (RTK) systems using data from known surveyed reference receivers. With respect to the code characteristics, the code tracking loop is far less sensitive than the carrier due to a slower transmit rate. In the case of GPS CA code on L1, the code tracking loop is 1540 times less sensitive. A benefit of the slower code rate is that the receiver can resolve the number of code chips between the receiver and transmitter allowing calculation of range (or pseudo range) back to the transmitter. To improve performance of signal tracking, both the hardware and software tracking allow for the use of Carrier Aided Code Phase tracking, where the rate commands from the carrier track are scaled and blended into the code tracking feedback.

When handing off tracking from software to hardware, the software signal tracking module 206 commands the hardware signal tracking logic circuit after sending signal tracking parameters via the hardware tracking setup and configuration 214. The software signal tracking module 206 further propagates velocity/acceleration aiding values to the hardware signal tracking logic circuit 208. The command is latched by the hardware signal tracking logic circuit 208 and takes effect at the next process cycle interval. The hardware signal tracking logic circuit 208 initializes tracking loop parameters including initial carrier loop velocity, then takes over tracking from the software signal tracking module 206. If a new solution is available, the software signal tracking module 206 recomputes the aiding values and sends those to the hardware signal tracking logic circuit 208. When handing off tracking from hardware to software, the software signal tracking module 206 terminates hardware tracking, captures hardware tracking loop states, and uses them to initialize the software tracking loops (this can be done ahead of time before the hardware to software handoff is commanded).

### Signal Tracking Flows

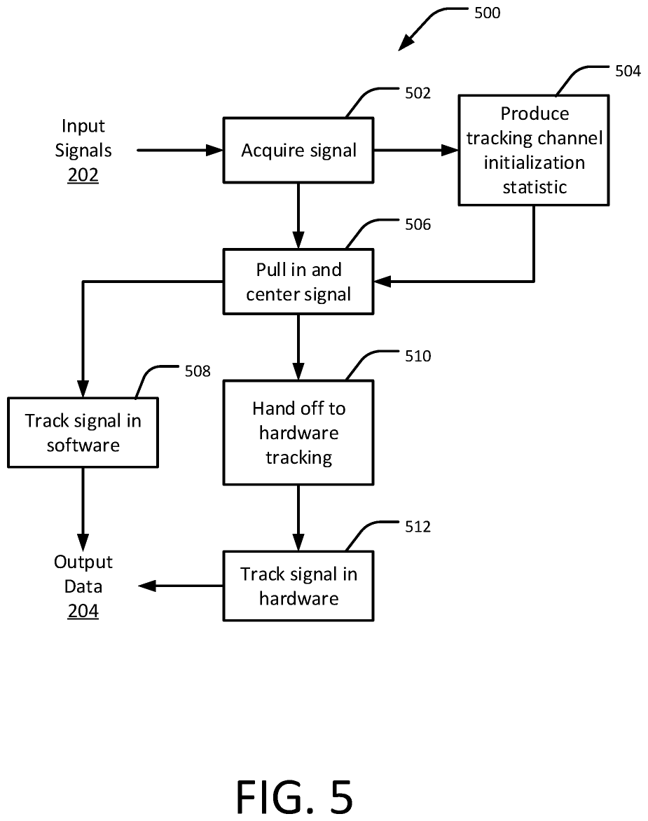

FIG. 5 is a flow diagram of an example signal tracking process 500, in accordance with an embodiment of the present disclosure. The process 500 can be implemented, for example, in the receiver 110 of FIG. 1. The process 500 receive one or more input signals 202, such as any of the satellite signals 106a, 106b, 106c, 106d, and produces output data 204, which can include positional and/or time data calculated from the one or more input signals 202. For example, the input signals 202 can include signals transmitted by, and received from, three or more of the satellites 102a, 102b, 102c, 102d in a GPS or other GNSS constellation, where each of the input signals 202 is encoded with information uniquely identifying the respective satellites (e.g., PRN codes). The process 500 includes acquiring 502 the input signals 202 using an acquisition process 302 that is designed for searching large time and frequency uncertainties. For example, the receiver 110 can acquire the signal by searching for the maximum detection statistic over a range of possible code start times and Doppler shifts. This is useful when the input signals 202 are weak, as received from a GNSS satellite. The statistic is calculated for each code start time and Doppler shift using Fast Fourier Transform (FFT)-based broadband mixing, code correlation, coherent integration, squaring, and non-coherent integration searching techniques.

Next, the process 500 includes producing 504 a statistic that is used to initialize a tracking channel in software. The process 500 further includes pulling in and centering 506 the input signals 202 in time and frequency (Doppler) before entering a tracking state where information can be used to compute range to the satellites. Tracking can be performed in software or hardware. In an example, the process 500 includes tracking 508 the input signals 202 in software. In another example, the process 500 includes handing tracking operations off 510 to hardware (e.g., the hardware signal tracking logic circuit 208) by providing a hardware tracking setup and configuration to the hardware. The hardware tracking setup and configuration enables the hardware to take over or otherwise assume tracking 512 the signal.

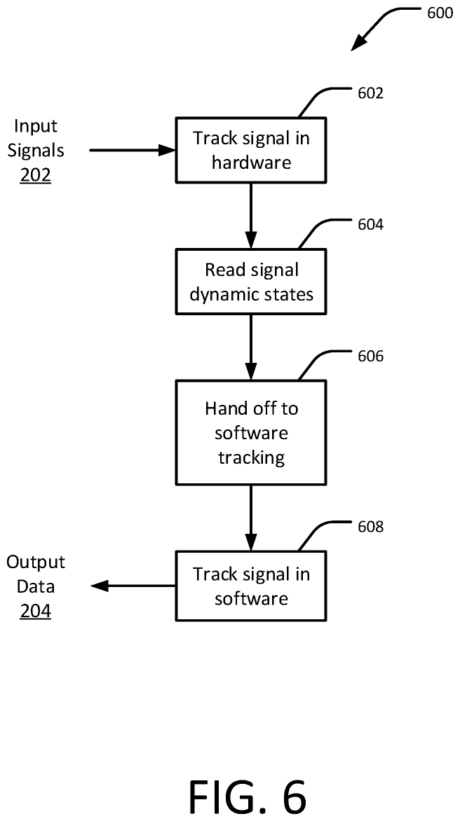

FIG. 6 is a flow diagram of another example signal tracking process 600, in accordance with an embodiment of the present disclosure. The process 600 can be implemented, for example, in the receiver 110 of FIG. 1. The process 600 includes tracking 602 the input signals 202 in hardware, such as described with respect to FIG. 5. The process 600 facilitates a transition from hardware tracking to software tracking, such as when tracking is lost due to signal interruption. The process 600 includes reading 604 the current signal dynamics states (e.g., the hardware tracking setup and configuration 214) from the hardware. Then, the process 600 hands off 606 signal tracking 608 to software (e.g., the software signal tracking module 206), which uses the current signal dynamics states to assume signal tracking operations. In some examples, signal tracking operations can subsequently be handed back to hardware, such as described with respect to FIG. 5, such as when the input signals 202 are reacquired.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional structures that include hardware, or a combination of hardware and software, and may comprise, for example, singly or in any combination, hardwired circuitry, programmable circuitry such as computer processors comprising one or more individual instruction processing cores, state machine circuitry, and/or gate level logic. The circuitry may include a processor and/or controller programmed or otherwise configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable device. In any such hardware cases that include executable software, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 provides a signal acquisition and tracking device. The device includes an input configured to receive a global satellite navigation system (GNSS) signal; a processor configured to execute software instructions to acquire the GNSS signal via the input and to generate, based on the acquired signal, one or more signal tracking parameters; and a logic circuit operatively coupled to the processor, the logic circuit configured to track the GNSS signal independently of the processor using the one or more signal tracking parameters generated by the processor.

Example 2 includes the subject matter of Example 1, and further includes a bidirectional communication channel between the processor and the logic circuit for communicating the one or more signal tracking parameters therebetween.

Example 3 includes the subject matter of any one of Examples 1 and 2, wherein the processor is further configured to pull in and center the GNSS signal in time and frequency, and wherein the logic circuit is further configured to track the pulled in and centered GNSS signal independently of the processor.

Example 4 includes the subject matter of Example 3, wherein the processor is further configured to hand off tracking of the GNSS signal to the logic circuit in response to pulling in and centering the GNSS signal.

Example 5 includes the subject matter of any of Examples 1-4, wherein the logic circuit includes a tracking correlator module configured to correlate, using a code delay and a carrier phase, a first ranging code in the GNSS signal and a second ranging code generated by the logic circuit.

Example 6 includes the subject matter of any of Examples 1-5, wherein the logic circuit further includes a signal tracking module configured to lock onto the GNSS signal based on the code delay and the carrier phase.

Example 7 includes the subject matter of any of Examples 1-6, wherein the logic circuit includes at least one of an application specific integrated circuit (ASIC) configured to track the GNSS signal and a field-programmable gate array (FPGA) configured to track the GNSS signal.

Example 8 includes the subject matter of any of Examples 1-7, and further includes an output operatively coupled to the logic circuit, wherein the logic circuit is further configured to generate, via the output, data representing a geographic position of the device based on the tracked GNSS signal.

Example 9 includes the subject matter of any of Examples 1-8, and further includes a memory operatively coupled to the processor and configured to store the instructions executable by the processor.

Example 10 includes the subject matter of any of Examples 1-9, and further includes a battery coupled to the processor and to the logic circuit.

Example 11 includes the subject matter of any of Examples 1-10, wherein the one or more tracking parameters include one or more of: a carrier and code loop controller gain term; a carrier and code discriminator configuration for computing a tracking error against a target value; a signal integration interval; and a waveform configuration value.

Example 12 provides a signal acquisition and tracking device. The device includes an input configured to receive a global satellite navigation system (GNSS) signal; a software signal tracking module configured to acquire the GNSS signal via the input and to generate, based on the acquired signal, one or more signal tracking parameters; and a hardware signal tracking logic circuit configured to track the GNSS signal independently of the software signal tracking module using the one or more signal tracking parameters generated by the software signal tracking module.

Example 13 includes the subject matter of Example 12, and further includes a bidirectional communication channel between the software signal tracking module and the hardware signal tracking logic circuit for communicating the one or more signal tracking parameters therebetween.

Example 14 includes the subject matter of any of Examples 12 and 13, wherein the software signal tracking module is further configured to pull in and center the GNSS signal in time and frequency, and wherein the hardware signal tracking logic circuit is further configured to track the pulled in and centered GNSS signal independently of the software signal tracking module.

Example 15 includes the subject matter of any of Examples 12-14, wherein the software signal tracking module is further configured to hand off tracking of the GNSS signal to the hardware signal tracking logic circuit in response to acquiring the GNSS signal.

Example 16 includes the subject matter of any of Examples 12-15, wherein the hardware signal tracking logic circuit includes a tracking correlator module configured to correlate, using a code delay and a carrier phase, a first ranging code in the GNSS signal and a second ranging code generated by the hardware signal tracking logic circuit.

Example 17 includes the subject matter of any of Examples 12-16, wherein the hardware signal tracking logic circuit further includes a signal tracking module configured to lock onto the GNSS signal based on the code delay and the carrier phase.

Example 18 includes the subject matter of any of Examples 12-17, wherein the hardware signal tracking logic circuit includes at least one of an application specific integrated circuit (ASIC) configured to track the GNSS signal and a field-programmable gate array (FPGA) configured to track the GNSS signal.

Example 19 includes the subject matter of any of Examples 12-18, and further includes an output operatively coupled to the software signal tracking module and the hardware signal tracking logic circuit, wherein the software signal tracking module and the hardware signal tracking logic circuit are each further configured to generate, via the output, data representing a geographic position of the device based on the tracked GNSS signal.

Example 20 includes the subject matter of any of Examples 12-19, and further includes a battery coupled to the software signal tracking module and to the hardware signal tracking logic circuit.

Example 21 provides a method of tracking a signal. The method includes acquiring, by a software signal tracking module, a global satellite navigation system (GNSS) signal; producing, by the software signal tracking module and based on the acquired signal, one or more signal tracking parameters; handing, by the software signal tracking module, signal tracking operations off to a hardware signal tracking logic circuit; and tracking, by the hardware signal tracking logic circuit, the GNSS signal independently of the software signal tracking module using the one or more signal tracking parameters generated by the software signal tracking module.

Example 22 includes the subject matter of Example 21, further including reading, by the hardware signal tracking logic circuit, one or more signal dynamic states; handing, by the hardware signal tracking logic circuit, signal tracking operations off to the software signal tracking module; and tracking, by the software signal tracking logic circuit, the GNSS signal using one or more signal dynamic states.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A signal acquisition and tracking device, comprising:
an input configured to receive a global satellite navigation system (GNSS) signal;
a processor configured to execute software instructions to acquire the GNSS signal via the input and to generate, based on the acquired signal, one or more signal tracking parameters; and
a logic circuit operatively coupled to the processor, the logic circuit configured to track the GNSS signal independently of the processor using the one or more signal tracking parameters generated by the processor.

2. The device of claim 1, further comprising a bidirectional communication channel between the processor and the logic circuit for communicating the one or more signal tracking parameters therebetween.

3. The device of claim 1, wherein the processor is further configured to pull in and center the GNSS signal in time and frequency, and wherein the logic circuit is further configured to track the pulled in and centered GNSS signal independently of the processor.

4. The device of claim 3, wherein the processor is further configured to hand off tracking of the GNSS signal to the logic circuit in response to pulling in and centering the GNSS signal.

5. The device of claim 1, wherein the logic circuit includes a tracking correlator module configured to correlate, using a code delay and a carrier phase, a first ranging code in the GNSS signal and a second ranging code generated by the logic circuit.

6. The device of claim 5, wherein the logic circuit further includes a signal tracking module configured to lock onto the GNSS signal based on the code delay and the carrier phase.

7. The device of claim 1, wherein the logic circuit includes at least one of an application specific integrated circuit (ASIC) configured to track the GNSS signal and a field-programmable gate array (FPGA) configured to track the GNSS signal.

8. The device of claim 1, further comprising an output operatively coupled to the logic circuit, wherein the logic circuit is further configured to generate, via the output, data representing a geographic position of the device based on the tracked GNSS signal.

9. The device of claim 1, further comprising a memory operatively coupled to the processor and configured to store the instructions executable by the processor.

10. The device of claim 1, further comprising a battery coupled to the processor and to the logic circuit.

11. The device of claim 1, wherein the one or more tracking parameters include one or more of:
a carrier and code loop controller gain term;
a carrier and code discriminator configuration for computing a tracking error against a target value;
a signal integration interval; and
a waveform configuration value.

12. A signal acquisition and tracking device, comprising:
an input configured to receive a global satellite navigation system (GNSS) signal;
a software signal tracking module configured to acquire the GNSS signal via the input and to generate, based on the acquired signal, one or more signal tracking parameters; and
a hardware signal tracking logic circuit configured to track the GNSS signal independently of the software signal tracking module using the one or more signal tracking parameters generated by the software signal tracking module.

13. The device of claim 12, wherein the software signal tracking module is further configured to pull in and center the GNSS signal in time and frequency, and wherein the hardware signal tracking logic circuit is further configured to track the pulled in and centered GNSS signal independently of the software signal tracking module.

14. The device of claim 12, wherein the software signal tracking module is further configured to hand off tracking of the GNSS signal to the hardware signal tracking logic circuit in response to acquiring the GNSS signal.

15. The device of claim 12, wherein the hardware signal tracking logic circuit includes a tracking correlator module configured to correlate, using a code delay and a carrier phase, a first ranging code in the GNSS signal and a second ranging code generated by the hardware signal tracking logic circuit.

16. The device of claim 15, wherein the hardware signal tracking logic circuit further includes a signal tracking module configured to lock onto the GNSS signal based on the code delay and the carrier phase.

17. The device of claim 12, wherein the hardware signal tracking logic circuit includes at least one of an application specific integrated circuit (ASIC) configured to track the GNSS signal and a field-programmable gate array (FPGA) configured to track the GNSS signal.

18. The device of claim 12, further comprising an output operatively coupled to the software signal tracking module and the hardware signal tracking logic circuit, wherein the software signal tracking module and the hardware signal tracking logic circuit are each further configured to generate, via the output, data representing a geographic position of the device based on the tracked GNSS signal.

19. A method of tracking a signal, the method comprising:
acquiring, by a software signal tracking module, a global satellite navigation system (GNSS) signal;
producing, by the software signal tracking module and based on the acquired signal, one or more signal tracking parameters;
handing, by the software signal tracking module, signal tracking operations off to a hardware signal tracking logic circuit; and
tracking, by the hardware signal tracking logic circuit, the GNSS signal independently of the software signal tracking module using the one or more signal tracking parameters generated by the software signal tracking module.

20. A method of claim 19, further comprising:
reading, by the hardware signal tracking logic circuit, one or more signal dynamic states;
handing, by the hardware signal tracking logic circuit, signal tracking operations off to the software signal tracking module; and
tracking, by the software signal tracking logic circuit, the GNSS signal using one or more signal dynamic states.
